(19) United States
(12) Patent Application Publication
(10) Pub. No.: US 2024/0162740 A1
(43) Pub. Date: May 16, 2024

(54) RESONANT CIRCUIT APPARATUS POWERED BY A SUPERCAPACITOR AND TOROIDAL INDUCTOR

(71) Applicant: ResonanceX Chile SpA, Las Condes (CL)

(72) Inventors: Harsimranjit Kaur, Toronto (CA); Lawrence Tseung, Hong Kong (CN)

(73) Assignee: ResonanceX Chile SpA, Las Condes (CL)

(21) Appl. No.: 18/506,374

(22) Filed: Nov. 10, 2023

Related U.S. Application Data
(60) Provisional application No. 63/424,545, filed on Nov. 11, 2022.

(51) Int. Cl. H02J 7/34; H02J 7/00

(52) U.S. Cl. CPC H02J 7/345; H02J 7/0063; H02J 7/007

(57) ABSTRACT

The present disclosure describes an electric circuit for powering a connectable load. The electric circuit includes a supercapacitor configured for connection in parallel to a removable power source capable of charging the supercapacitor, a toroid inductor having a primary winding and a secondary winding, a base biasing resistor, and a transistor. The secondary winding connected in series to the base biasing resistor, and to the base, the primary connected to the collector, the emitter connected the supercapacitor, and the load connected across the collector-emitter junction of the transistor. When the charged supercapacitor discharges, the primary and secondary windings incite the transistor to alternate between a saturation region and a cut off region at a resonance frequency, directing current to the supercapacitor through the collector-emitter junction of the transistor while in the saturation region, and directing current with high voltage to the load while in the cut off region.

### FIELD OF INVENTION

The present disclosure relates generally to the use of resonance circuits that include toroid inductors, and more particularly to the increase of voltage output and duration of time power can be provided to a load through the number of turns for the primary winding and the secondary winding in toroid inductors in resonance circuits.

### BACKGROUND OF THE INVENTION

Resonance circuits can take energy from nearly depleted batteries and increase the output voltage at the expense of a higher current draw. Some problems associated with this process are the difficulty in ensuring that the voltage output is high enough, and that the voltage can be provided over an extended period of time while using minimum power from a power source.

Furthermore, while resonance circuits may have different arrangements of components, they are limited in that they require a power source that is connected to the resonance circuit at all times, and hence the portability of the resonance circuit may be limited, as the weight of the power source also needs to be considered.

### SUMMARY OF THE INVENTION

According to various aspects of the present invention, there is provided an electric circuit. The electric circuit includes a supercapacitor configured for connection in parallel to a removable power source capable of charging the supercapacitor, the supercapacitor having a positive terminal and a negative terminal. The electric circuit also includes a toroid inductor being configured to receive current from the positive terminal of the supercapacitor when the supercapacitor is actuated to discharge, the toroid inductor having a primary winding and a secondary winding, the primary winding and the secondary winding having a plurality of turns. Additionally, the circuit includes a transistor including a collector, a base, an emitter and a collector-emitter junction. Furthermore, the electric circuit includes a base biasing resistor being configured to ensure the base of the transistor receives safe current. The toroid inductor, the base biasing resistor, the transistor, and a connectable load are connected in parallel to the supercapacitor. The secondary winding of the toroid inductor is connected in series to the base biasing resistor, which in turn is connected to the base of the transistor, the primary winding of the toroid inductor is connected in series to the collector of the transistor, the emitter of the transistor is connected to the negative terminal of the supercapacitor, and the connectable load is connected across a collector-emitter junction of the transistor. Once charged, the supercapacitor is actuable to discharge so as to cause the primary and secondary windings to incite the transistor to alternate between a saturation region and a cut off region at a resonance frequency, to direct current to the supercapacitor through the collector-emitter junction of the transistor while the transistor is in the saturation region, and to direct current with high voltage to the load while the transistor is in the cut off region.

The number of turns around the primary winding and secondary winding of the toroid inductor may be directly proportional to an operation time of the load.

The number of turns around the primary winding and secondary winding of the toroid inductor may be inversely proportional to the resonance frequency.

The operation time of the load may be inversely proportional to the resonance frequency.

The diameter of a toroid core of the toroid inductor may be directly proportional to an operation time of the load.

The diameter of a toroid core of the toroid inductor may be inversely proportional to the resonance frequency.

The electric circuit may further includes an input current sensing resistor connected between the emitter of the transistor and the negative terminal of the super capacitor, the input current sensing resistor being configured to aid in the measurement of the current input flowing through the supercapacitor.

The electric circuit may also further include comprising an output current sensing resistor connected in series to an output of the load, the output current sensing resistor and the load connected across a collector-emitter junction of the transistor, the output current sensing resistor being configured to aid in the measurement of current output supplied to the load.

The number of turns around the primary winding and the secondary winding of the toroid inductor may be directly proportional to an average coefficient of power for the electric circuit.

The number of turns around the primary winding and the secondary winding of the toroid inductor may be directly proportional to a peak coefficient of power for the electric circuit while the transistor is in the cut off region.

In an embodiment of the electric circuit, the removable power source is a depleted battery.

Furthermore, the depleted battery is an alkaline AA battery that has a voltage of 1.3 volts or less.

In another embodiment of the electric circuit, the removeable power source is an AA battery that has a voltage between 1.0 volt and 1.5 volts.

In another embodiment of the electric circuit, the supercapacitor has a capacitance of between 10 farads and 25 farads.

In another embodiment, the supercapacitor is an electric double-layer capacitor.

In yet another embodiment, the supercapacitor is a hybrid supercapacitor.

In yet another embodiment, prior to the supercapacitor being actuated to discharge, the power source is connected in parallel to the supercapacitor for a duration of at least 1 second to charge the supercapacitor and then the power source is subsequently disconnected.

In one embodiment, the removable power source may be a removable battery with voltage between 1.25 volts and 1.3 volts.

Furthermore, in the embodiment, the supercapacitor may be charged by connecting the removable battery for a duration of at least 9 seconds and then disconnecting the removable battery.

In addition, the supercapacitor may have a capacitance of 10 farads.

In addition, the primary winding and secondary winding may each have between 4 to 35 turns.

In addition, the frequency of resonance may be between 120 kHz and 7.35 kHz.

In an alternate embodiment, the supercapacitor may have a capacitance of 25 farads.

In addition, the primary winding and secondary winding may each have between 25 to 35 turns.

In addition, the frequency of resonance may be between 2.40 kHz and 1.62 kHz.

According to various aspects of the present invention, there is provide a method of powering a load. The method includes providing a supercapacitor configured for connection in parallel with a removable power source, the supercapacitor having a positive terminal and a negative terminal. The method further includes providing a toroid inductor, a base biasing resistor, a transistor and a connectable load connected in parallel with the supercapacitor, the toroid inductor connected to the positive terminal of the supercapacitor, the toroid inductor having a primary winding and a secondary winding, the primary winding and the secondary winding having a plurality of turns, the transistor including a collector, a base, an emitter, and a collector-emitter junction. The method further includes providing the secondary winding of the toroid inductor being connected in series to the base biasing resistor, which in turn is connected to the base of the transistor, the primary winding of the toroid inductor being connected to the collector of the transistor, the emitter of the transistor being connected to the negative terminal of the supercapacitor, and the connectable load being connected across a collector-emitter junction of the transistor. Furthermore, the method includes charging the supercapacitor through connecting the removable power source for a predetermine duration of time, and subsequently disconnecting the removable power source. In addition, the method includes discharging a current from a charged supercapacitor to the toroid inductor. The method also includes inciting the transistor to alternate between a saturation region and a cut off region at a resonance frequency using the primary winding and secondary winding of the toroid inductor. Furthermore, while the transistor in a saturation region, the method includes directing current to the supercapacitor through the collector-emitter junction of the transistor. In addition, while the transistor in a cut off region, the method includes directing current with high voltage to the load.

The number of turns around the primary winding and secondary winding of the toroid inductor may be directly proportional to an operation time of the load.

The number of turns around the primary winding and secondary winding of the toroid inductor may be inversely proportional to the resonance frequency.

The operation time of the load may be inversely proportional to the resonance frequency.

The diameter of a toroid core of the toroid inductor may be directly proportional to an operation time of the load.

The diameter of a toroid core of the toroid inductor may be inversely proportional to the resonance frequency.

The number of turns around the primary winding and the secondary winding of the toroid inductor may be directly proportional to an average coefficient of power for the electric circuit.

The number of turns around the primary winding and the secondary winding of the toroid inductor may be directly proportional to a peak coefficient of power for the electric circuit while the transistor is in the cut off region.

In one embodiment, the removable power source is a depleted battery.

Furthermore, the depleted battery may be an alkaline battery that has a voltage of 1.3 volts or less.

In another embodiment, the removable power source is an AA battery that has a voltage between 1.0 volt and 1.5 volts.

In yet another embodiment, the supercapacitor may have a capacitance between 10 farads and 25 farads.

In yet another embodiment, the predetermined duration of time where the removable power source is connected to charge the supercapacitor is at least 1 second.

In yet another embodiment, the predetermined duration of time is between 9 seconds and 12 seconds.

In yet another embodiment, the predetermined duration of time is between 9 seconds and 10 seconds.

According to various aspects of the present invention, there is provided an electric circuit. The electric circuit includes a supercapacitor having a capacitance between 10 farads and 25 farads, the supercapacitor configured for connection in parallel to a removable power source capable of charging the supercapacitor. The removable power source has less than 1.3 volts, and the supercapacitor has a positive terminal and a negative terminal. The electric circuit also includes a toroid inductor being configured to receive current from the positive terminal of the supercapacitor when the supercapacitor is actuated to discharge, the toroid inductor having a primary winding and a secondary winding, the primary winding and the secondary winding each having between 4 to 35 turns. Additionally, the circuit includes a transistor including a collector, a base, an emitter and a collector-emitter junction. Furthermore, the electric circuit includes a base biasing resistor being configured to ensure the base of the transistor receives safe current. The toroid inductor, the base biasing resistor, the transistor, and a connectable load are connected in parallel to the supercapacitor. The secondary winding of the toroid inductor is connected in series to the base biasing resistor, which in turn is connected to the base of the transistor, the primary winding of the toroid inductor is connected in series to the collector of the transistor, the emitter of the transistor is connected to the negative terminal of the supercapacitor, and the connectable load is connected across a collector-emitter junction of the transistor. Once charged by the removable power source for a duration of at least 9 seconds, the supercapacitor is actuable to discharge so as to cause the primary and secondary windings to incite the transistor to alternate between a saturation region and a cut off region at a resonance frequency, to direct current to the supercapacitor through the collector-emitter junction of the transistor while the transistor is in the saturation region, and to direct current with high voltage to the load while the transistor is in the cut off region.

In another embodiment of the electric circuit, the supercapacitor has a capacitance of 10 farads, and the primary winding and secondary winding each have between 4 to 35 turns.

In yet another embodiment of the electric circuit, the supercapacitor has a capacitance of 25 farads, and the primary winding and secondary winding each have between 25 to 35 turns.

### BRIEF DESCRIPTION OF THE DRAWINGS

The embodiments of the present invention shall be more clearly understood with reference to the following detailed description of the embodiments of the invention taken in conjunction with the accompanying drawings, in which:

FIG. 1 is a circuit diagram of a resonant circuit powered by a supercapacitor and toroidal inductor according to an embodiment of the present invention.

FIG. 2 is an isolated view of the toroidal inductor included in the circuit as depicted in FIG. 1.

FIG. 3 depicts a waveform of the output resonance frequency curves of the circuit of FIG. 1, the measurement taken between the transistor and the secondary winding of the toroidal inductor, after a battery had been attached to the circuit for 10 seconds, and then removed from the circuit, and the supercapacitor discharging power to a load, and where the toroidal inductor includes 32 turns of wire around the toroid core for the primary and secondary windings, where the x-axis represents time, and the y-axis represents voltage.

FIG. 4 depicts a magnified view of the waveform of FIG. 3, where a cycle of the waveform has been divided into separate areas for the calculation of the area under the waveform to determine average output voltage.

FIG. 5 depicts a waveform of the output resonance frequency curve of the circuit of FIG. 1, the measurement taken across the output current sensing resistor, under the same conditions as those of FIG. 3, where the x-axis represents time and the y-axis represents current.

FIG. 6 depicts a magnified view of the waveform of FIG. 5, where a cycle of the waveform has been divided into separate areas for the calculation of the area under the waveform to determine average output current.

FIG. 7 depicts a waveform of the input resonance frequency curve of the circuit of FIG. 1, the measurement taken across the input current sensing resistor, under the same conditions as those of FIG. 3, where the x-axis represents time, and the y-axis represents current.

FIG. 8 depicts a magnified view of the waveform of FIG. 7, where a cycle of the waveform has been divided into separate areas for the calculation of the area under the waveform to determine average input current.

### DESCRIPTION OF THE PREFERRED EMBODIMENTS OF THE INVENTION

The description, which follows, and the embodiments described therein are provided by way of illustration of an example, or examples of particular embodiments of principles and aspects of the present invention. These examples are provided for the purposes of explanation and not of limitation, of those principles of the invention. In the description that follows, like parts are marked throughout the specification and the drawings with the same respective reference numerals.

By way of general overview, there is provided an apparatus for providing an electrical charge to a load, such as light emitting diodes (LEDs) or mobile devices, by using harvested energy from the residual energy of batteries that are considered to have been nearly depleted after being used. The apparatus includes a resonant circuit, where the resonant circuit includes a supercapacitor, and a toroidal inductor. The advantage of using a supercapacitor and a toroidal inductor is that after the resonance frequency is induced by the toroidal inductor in said circuit 100 configuration, the supercapacitor and the toroidal inductor maintain a resonant frequency throughout the circuit to maintain the power in the circuit to enable the load to be powered even when the battery or the source voltage is removed, thereby allowing the harvested energy to be used more efficiently.

Furthermore, the advantage of having a supercapacitor as part of the resonance circuit allows for the removal of the battery, and hence allows for further efficiencies to be gained through the use of discrete power units and the saving of additional power in the battery once removed. In addition, the removal of the battery reduces the weight of the resonance circuit, allowing for additional portability of the resonance circuit to power different loads in different locations.

However, further efficiency may be gained through the design of the toroidal inductor (also referred to herein as a toroid inductor). More specifically, the number of turns for the primary winding and the secondary winding in the toroid inductor may be adjusted to ensure that a higher peak voltage output is achieved and to ensure that the total time the high output voltage is provided after the battery has been removed is as long as possible. The size of the toroid inductor may also present further efficiencies. Furthermore, efficiencies may also be gained by varying the capacitance size of the supercapacitor. The present disclosure provides an apparatus employing a circuit with a toroid inductor and a supercapacitor, in which the toroid inductor has been optimized in size and with the number of turns for primary and secondary windings to provide peak voltage for a higher operation time, and where the supercapacitor has been optimized in capacitance size.

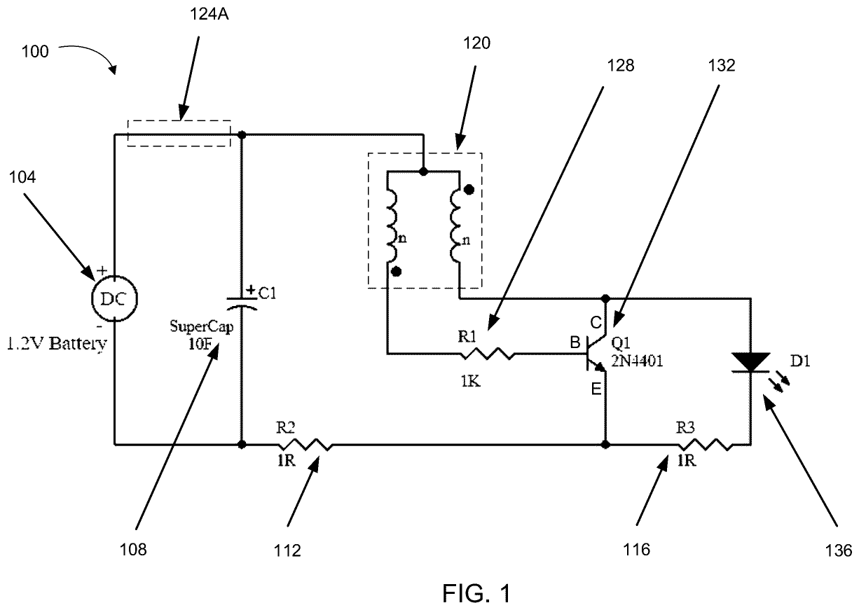

FIG. 1 depicts a circuit 100 for harvesting energy from nearly depleted batteries, and using the energy to power a load. More specifically, circuit 100 includes a resonant circuit configured to be powered by a supercapacitor and a toroid inductor, where the supercapacitor is used to store the energy provided from the nearly depleted batteries, and the toroid inductor is used to ensure the circuit remains at a specific resonant frequency for efficient energy use. Circuit 100 includes battery 104 as a power source, and is connected in parallel with supercapacitor 108 and the remainder of the circuit. The remainder of the circuit includes toroid inductor 120, resistors 112, 116 and 128, transistor 132, and load 136 connected in the configuration as seen in FIG. 1. As can be seen, toroid inductor 120, resistors 112, 116 and 128, transistor 132, which form a loop/closed circuit (and will be discussed further below in said loop configuration), and load 136 are connected in parallel to supercapacitor 108 and connected in parallel to battery 104. The configuration of the components will be further discussed below.

Circuit 100 is designed to store energy from battery 104 using supercapacitor 108. Battery 104 may then be removed after charging supercapacitor 108. Supercapacitor 108 may be charged fully or may be partially charged depending on the type of battery 104, and the length of time battery 104 stays connected to circuit 100 providing power to supercapacitor 108. Due to current running through toroid inductor 120 and transistor 132 alternating between on and off states, a plurality of high voltage output pulses are delivered to load 136. This leads to load 136 being powered for a greater period of time compared to a circuit with a capacitor discharging to a load without a toroid inductor 120.

In the current embodiment, where an AA battery is used as battery 104, and a low power LED is used as load 136, if circuit 100 is powered by battery 104 for nine to ten seconds to charge supercapacitor 108, the low power LED load 136 can be powered for about fifteen to eighteen minutes within the circuit configuration of circuit 100 from the discharge of supercapacitor 108. More specifically the LED may be powered for approximately ten minutes at a normal brightness level, and then for five to eight minutes at a lower brightness level, depending on the configuration of toroid inductor 120. The configuration of toroid inductor 120 will be further discussed below.

Battery 104 is a power source that provides voltage to circuit 100. Battery 104 may be any power source that provides voltage to circuit 100, including, but not limited to an electrical outlet, or other energy storage devices, such as batteries or fuel cells, generators, alternators, or solar power converters. Specifically, while in the current embodiment, battery 104 is a direct current (“DC”) energy source, battery 104 may also be an alternating current (“AC”) energy source. If an AC energy source, such as an electrical outlet, is used, an AC to DC power converter may be provided in series between battery 104 and the remainder of the circuit, allowing the conversion of AC power to DC power prior to providing power through circuit 100. In the current embodiment, battery 104 is preferably a depleted alkaline AA battery, where a depleted alkaline AA battery may be considered to be an alkaline AA battery that has a voltage of 1.3 volts or less, preferably in the range of 1 volt to 1.3 volts, more preferably between 1.1 volts and 1.3 volts, and still more preferably between 1.2 volts and 1.3 volts. More specifically, a depleted alkaline AA battery may be considered to be an alkaline AA battery that has approximately 87% or less of its rated voltage, preferably in the range of 67% to 87% of its rated voltage, more preferably between 73% to 87% of its rated voltage, and still more preferably between 80% to 87% of its rated voltage.

While it is preferred to use a depleted battery, a person skilled in the art will recognize that the circuit 100 will continue to operate with an alkaline AA battery that has a voltage between 1.3 volts and 1.5 volts. A person skilled in the art will also recognize that the circuit 100 will continue to operate with an alkaline AA battery that has a voltage between 1.0 volt and 1.5 volts.

Furthermore, in alternate embodiments, battery 104 may be of any voltage and of any type, including, but not limited to, a AAA battery, a D cell battery, a 9 volt battery, or even a 12 volt battery. Additionally, in alternate embodiments, battery 104 may be a rechargeable battery, such as a NiMH battery or a lithium-ion battery. A person skilled in the art will also recognize that depending on the battery type and voltage of battery 104, that such batteries each have their own threshold for depletion. A person skilled in the art will recognize the various configurations and different type of power sources available for powering circuit 100 and charging supercapacitor 108.

While circuit 100 will continue to operate with non-depleted batteries or other power sources, the advantages of circuit 100 are greatly realized when difficult to extract sources of power due to low voltage, such as nearly depleted batteries, are used to provide power to load 136. In a preferred embodiment, during normal operation, a nearly depleted battery 104 may be placed into circuit 100 to charge supercapacitor 108. The battery 104 may be removed and reattached multiple times, wherein each instance where battery 104 is connected, it charges supercapacitor 108, after which battery 104 may then be detached from circuit 100. Once fully depleted, battery 104 may be replaced with another nearly depleted battery 104 to continue charging supercapacitor 108. In alternate embodiments, a plurality of batteries 104 may also be placed in parallel or in series to power circuit 100 and charge supercapacitor 108.

Battery 104 is connected in parallel with supercapacitor 108. In the current embodiment, supercapacitor 108 has a higher capacitance value in the order of Farads, and hence stores charge from battery 104 and is able to maintain the charge. The charge that is stored may then be discharged into the remainder of the circuit as needed. A person skilled in the art will recognize that different capacitance values of supercapacitor 108 may be used, and that the capacitance value of supercapacitor 108 may vary depending on variables of the components of circuit 100 and the operation of circuit 100, including, but not limited to, the type of battery 104 being used, the load on circuit 100, and also the length of time that battery 104 is powering circuit 100 to charge supercapacitor 108 prior to being disconnected. Controlling the charge and discharge will be discussed further below. When charging supercapacitor 108, a single battery 104, multiple batteries 104, or a series of batteries 104 being replaced as each battery 104 fully depletes and can no longer provide supercapacitor 108 with any charge may be used.

Supercapacitor 108 may be any form of supercapacitor, including electric double-layer capacitors (“EDLC”), and hybrid supercapacitors. An embodiment with an EDLC supercapacitor and an alternate embodiment with a hybrid supercapacitor will further discussed below. A person skilled in the art will recognize the different configurations that may be used with the different types of supercapacitors 108 to store energy to be discharged to the remainder of circuit 100.

While not provided in FIG. 1, the parallel configuration of battery 104 provides a charge to supercapacitor 108 and the remainder of the circuit may be separated by a switch. The switch may be located between the parallel branch containing supercapacitor 108 and the remaining components of circuit 100. More specifically, the switch may be located along the second parallel branch which includes toroid inductor 120, resistors 112, 116 and 128, transistor 132 and load 136. Examples of locations for the switch may include region 124A. The switch allows for the connection and disconnection of the battery from the remainder of the circuit 100, hence allowing for the interruption of the charging of supercapacitor 108 from a charged battery 104.

It is also contemplated that, while not depicted, a switch may also be placed on either side of battery 104 to disconnect battery 104 from supercapacitor 108 in the event that supercapacitor 108 needs to be fully discharged, discharging its charge to the remainder of circuit 100 and load 136. Alternatively, if a switch is not used, battery 104 may be removed from the circuit when supercapacitor 108 needs to be fully discharged. A person skilled in the art will recognize the different configurations of circuit 100, or components that may be added to circuit 100 to ensure that battery 104 is electrically isolated from circuit 100 when supercapacitor 108 needs to be fully discharged.

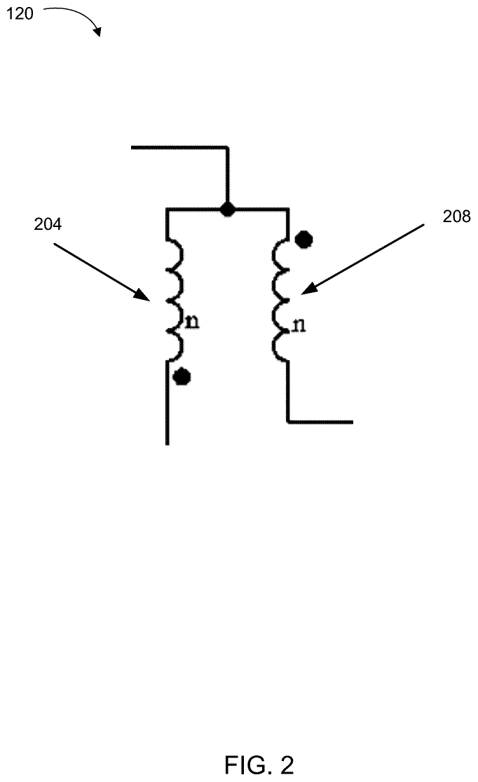

Turning now to toroid inductor 120, toroid inductor 120 is connected to supercapacitor 108 in series. More specifically, toroid inductor 120 includes secondary winding 204 and primary winding 208, where the positive end of the supercapacitor 108 is connected to the junction of the secondary winding 204 and primary winding 208, and where secondary winding 204 is connected in series to base biasing resistor 128, and primary winding 208 is connected to the collector of transistor 132, denoted with “C” at transistor 132. Base biasing resistor 128 is then connected with the base of transistor 132, denoted with “B” at transistor 132. In essence, the transistor 132, toroid inductor 120 and base biasing resistor are part of a loop (also referred to herein as a third leg), specifically: secondary winding 204 of toroid inductor 120, base biasing resistor 128, transistor 132 and primary winding 208. The flow of current through said loop and base biasing resistor 128 will be further discussed below. Toroid inductor 120 uses a magnetic core with a toroidal shape wound with wire. The magnetic core is made of ferromagnetic material, such as laminated iron, iron powder, or ferrite. In the current embodiment, toroid inductor 120 includes a toroid ferrite core with copper wire windings. More specifically, the toroid ferrite core is an epoxy N87 ferrite core with a width of 10.80 millimetres, a diameter of 4.75 millimetres, and a height of 4.0 millimetres, and is wound with a 30 American wire gauge (“AWG”) enameled copper wire. An advantage of using a toroid shaped inductor is that unlike other core shapes, such as rectangular-shaped cores, the shape is symmetrical and does not include any shape bends, allowing for a reduction in the escape of magnetic flux. As such, toroid inductor 120 is more efficient and radiates less electromagnetic interference. As previously indicated above toroid inductor 120 includes two windings, a secondary winding 204 and a primary winding 208, that are inductively coupled in opposing directions. An equal number of turns between the primary and secondary windings is preferred as using an unequal number of turns yields sub-optimal results and resonance is not achieved. Resonance will be further discussed below. Referring to FIG. 2, in the current embodiment, toroid inductor 120 can be seen to include secondary winding 204 and primary winding 208. A person skilled in the art will recognize that various configurations of toroid inductor 120 may be used, including toroid inductors 120 with cores of different materials and sizes. As an example, toroid inductors with an outer diameter of 10.80 mm, 20 mm, 22.1 mm and 25.3 mm will be discussed below.

Returning to FIG. 1, transistor 132, may be any NPN bipolar junction transistor. As can be seen in FIG. 1, transistor 132 is located in circuit 100, where the base of transistor 132 is connected in series with base biasing resistor 128 and secondary winding 204, the collector of transistor 132 is in connected with primary winding 208, and the emitter of transistor 132, denoted with “E” at transistor 132, is connected to the negative terminal of the supercapacitor through the input current sensing resistor 112. The combination of transistor 132 and toroid inductor 120 in the configuration displayed in FIG. 1, allows for high voltage spikes (also referred to herein as high voltage pulses) to be passed onto load 136, the voltage spike having a much higher voltage than that provided by battery 104 or supercapacitor 108 when operated without the toroid inductor 120 and the transistor 132.

Resistor 128 is a base biasing resistor. In the current embodiment, resistor 128 has a value of one (1) kiloohm and a power rating of one (1) Watts. Base biasing resistor 128 is configured for the safe operation of transistor 132 by limiting the amount of current provided to transistor 132. A person skilled in the art will recognize that the power ratings for resistor 128 may be adjusted based on the type, size, and specifications of transistor 132.

In circuit 100, load 136 is a LED. However, load 136 may be any form of electrical load or component that consumes electrical power, and is not limited to low power devices, such as an LED. For example, load 136 may be a USB port to charge mobile devices. A person skilled in the art will also recognize that depending on the voltage specifications of load 136, additional batteries 104 (in series) may be required to provide said voltage. In the current embodiment, a series combination of the load 136 and the output current sensing resistor 116 is connected across the collector-emitter junction of transistor 132. Output current sensing resistor 116 will be further discussed below.

Output current sensing resistor 116 is a current sensing resistor and allows for the measuring of current by monitoring the voltage drop across output sensing resistor 116. As indicated above, output current sensing resistor 116 is connected to load 136 in series. By being connected in series to load 136, the current downstream from load 136 may be measured.

Input current sensing resistor 112 is similarly a current sensing resistor and similarly allows for the measuring of current by monitoring the voltage drop across input current sensing resistor 112. Input current sensing resistor 112 is connected in series with supercapacitor 108, along the path of the input current flow, so as to measure the current entering supercapacitor 108/flowing through the input side of supercapacitor 108.

In the current embodiment, current sensing resistors 112 and 116 both have a value of one (1) ohm, and a power rating of one (1) Watts. However, different power ratings may be used, so long as the specifications and values of the resistor are known to calculate the current based on the voltage drop, and so long as the power ratings are not significant enough to affect the functioning of circuit 100. For example, in the current embodiment, with the resistance value known, the value of the voltage measured across the resistor may allow for the calculation of the current.

A person skilled in the are will recognise that output current sensing resistor 116 and input current sensing resistor 112 are used for the measurement of current at different locations along circuit 100, and are optional for the functioning of circuit 100. A person skilled in the art will also recognize that any number of current sensing resistors may be placed at any location along circuit 100 to measure current, so long as the placement of the current sensing resistor does not impact the functioning of circuit 100.

Operation of circuit 100 has two stages: the charging stage and the discharging stage. The charging stage of circuit 100 includes attaching battery 104 to the circuit to charge supercapacitor 108. Battery 104 may be removed after a period of time of charging supercapacitor 108 or alternatively, battery 104 may be removed after complete depletion. The capacity of supercapacitor 108 may affect the length of time that battery 104 may be connected to fully charge supercapacitor 108, however supercapacitor 108 does not need to be fully charged for the operation of circuit 100. Once supercapacitor 108 reaches a charge threshold, power that is discharged from supercapacitor 108 may power up load 136. Prior to supercapacitor 108 reaching the charge threshold, the effect on load 136 is not observable. A person skilled in the art will recognize that the charge threshold depends on load 136. For example, where load 136 is a LED which requires 2.9 volts to be powered, supercapacitor 108 will continue to charge and discharge, however load 136 will not power up until the charge threshold of at least 2.9 volts to supply to load 136 is reached. Effectively, the LED will not light up, and is hence the effect on load 136 is not observable, until the charge threshold of 2.9 volts is reached by supercapacitor 108. Once the charge threshold is met, the LED will light up Similarly, where load 136 may require a higher voltage to power up, the charge threshold supercapacitor 108 will need to be charged to match said high voltage. A level of charge a supercapacitor 108 receives may affect the output voltage and the length of time of operation of the circuit in powering load 136.

The discharging stage of circuit 100 includes supercapacitor 108 discharging the current stored from the charging stage of circuit 100, towards toroid inductor 120. In the current embodiment, supercapacitor 108 need not be fully charged before beginning to discharge to the remainder of circuit 100, but may also continue to be charged while discharging. However, it will occur to a person skilled in the art that in other embodiments components (such as switches) may be added to circuit 100 to allow for supercapacitor 108 to be fully changed before being discharged to the remainder of circuit 100. As such, it will occur to a person skilled in the art that in various configurations, the charging state and discharging state of supercapacitor 108 may be either in distinct separate states, or may operate concurrently.

While supercapacitor 108 is in a discharge state, current from supercapacitor 108, flows through secondary winding 204 of toroid inductor 120. The current flowing through secondary winding 204 and the base biasing resistor 128, provides a positive voltage to the base of transistor 132. The transistor 132 begins to operate in the linear region which generates collector current. This current then starts to flow through the primary winding 208. As primary winding 208 and secondary winding 204 are inductively coupled in opposite directions, a positive voltage is induced in secondary winding 204 which further creates a higher bias at the base B transistor 132. Hence, the current will increase in primary winding 208. The increasing positive feedback creates a magnetic field and drives transistor 132 to enter the saturation region (also referred to herein as the transistor 132 being in the fully “ON” state), effectively turning the transistor on and closing the collector and emitter junction of transistor 132. In this state, the current does not flow to load 136, as the path of least resistance for the current is through the collector-emitter junction of transistor 132. This leaves load 136 unpowered. The current in the primary winding 208 increases until becoming proportional to the input voltage from the supercapacitor 108, where the current reaches its maximum value and plateaus. As the increase of current across primary winding 208 plateaus, the positive feedback magnetic field collapses, resulting in the base emitter voltage falling below its threshold voltage. Eventually, transistor 132 enters the cut-off region, opening the circuit between the emitter and collector of transistor 132 (also referred to herein as the transistor 132 being in an “OFF” state). The residual energy stored in the secondary winding 204 cannot go through the transistor 132 and hence the current flows through the only available path i.e., through the load 136. The collapse of the magnetic field causes a voltage spike and thus a higher voltage across the load 136, much higher than the voltage across the supercapacitor 108 positive terminal and negative terminal. Once the energy stored in the secondary winding 204 is fully dissipated in the load 136, the entire sequence of transistor 132 turning ON and OFF repeats.

As the energy dissipates, and the magnetic field returns to zero, the sequence repeats itself, and voltage across supercapacitor 108 increases the current through secondary winding 204, moving transistor 132 from the cut off region back towards the saturated region. As such, transistor 132 alternates between an ON and OFF state, or more specifically, alternates between the saturation region and the cut-off region. The transition between the ON and OFF states is at a fixed frequency, also known as the resonance frequency. The resonance frequency alternates quickly enough that load 136 appears to be continuously powered to the naked eye, despite the current only running through load 136 in high voltage pulses.

The sequence repeats itself until all energy in supercapacitor 108 has been discharged or when the frequency of resonance drops below a resonance frequency threshold, at which time, supercapacitor 108 requires additional charge from battery 104 to power the load 136. The resonance frequency threshold is dependent on load 136. In the current embodiment, where load 136 is a LED, the resonance frequency threshold is 12 kHz. A person skilled in the art will recognize that different loads 136 will have different resonance frequency thresholds. Alternatively, switches may be opened and closed to enable supercapacitor 108 to be charged again with battery 104, as long as battery 104 continues to have charge. If battery 104 is fully depleted, it may be replaced with another battery 104.

By transistor 132 cycling between the saturation region and the cut off region, and turning ON and OFF at the resonance frequency, pulses of power at a higher voltage can be provided to load 136, the power appearing to be continuous, until there is no charge left to maintain the resonance frequency.

The operation of the circuit at a resonance frequency is a result of the combination of supercapacitor 108 and toroid inductor 120 affecting transistor 132. If a resonance frequency is not reached, then high voltage pulses are not provided to load 136, and sufficient current does not reach load 136. A person skilled in the art will recognize that only specific combinations of toroid inductor 120 and supercapacitor 108 will reach resonance frequency and allow for high voltage pulses to reach load 136 over an elongated period of time. The configurations of toroid inductor 120 may vary depending on variables including the size of toroid inductor 120 and the number of turns around secondary winding 204 and primary winding 208. Similarly, the configurations of supercapacitor 108 include its capacitance value.

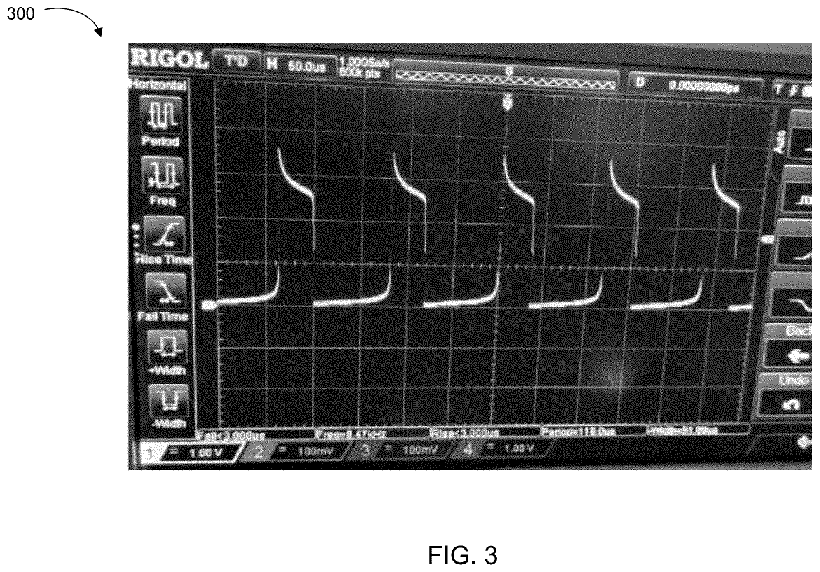

FIG. 3 depicts waveform 300, where the x axis is time and they axis is voltage. As can be seen, the waveform of the resonance frequency shows high voltage spikes as transistor 132 alternates between an on and off state.

As is described above, ensuring toroid inductor 120 sets up and maintains a proper resonance frequency allows the circuit 100 to continue functioning and providing power to the load 136.

To maximize efficiency, toroid inductor 120 may be optimized based on the number of turns for the primary and secondary windings 204 and 208 around the toroid core.

### EXAMPLES

The following are exemplary circuits using the following: number of turns around secondary winding 204 and primary winding 208, the toroid core size, and the capacitance of supercapacitor 108.

### Example 1

The table below, Table 1, depicts the results from Example 1, specifically a table of values measured across the circuit depicted in FIG. 1, the values measured including the peak voltage, total operation time of an LED in the circuit, and the initial frequency of resonance in the circuit, as the number of turns of the primary and secondary windings 204 and 208 of wires around toroid ferrite core for toroid inductor 120 are changed. As previously mentioned, an equal number of turns is optimal for secondary winding 204 and primary winding 208. As such for line one of Table 1, four turns are for secondary winding 204, and four turns are for primary winding 208. Measurements were taken after circuit 100 was powered, and supercapacitor 108 charged using battery 104 with voltage between 1.25 volts to 1.3 for a duration of 9 to 10 seconds, after which battery 104 was removed from circuit 100. In this embodiment, supercapacitor 108 was an EDLC type supercapacitor and had a capacitance of 10 farads. In addition, in this embodiment, the toroid inductor had an outer diameter of 10.80 mm, an inner diameter of 5.25 mm and a height of 4.75 mm. The time the LED remains operational was then recorded, along with peak voltage and the initial frequency of resonance. For clarity, the total operation time provided in Tables 1 to 4, and also referred to herein, represents the total time that the LED is on, regardless of the brightness of the LED.

TABLE 1
Affects of Multiple Windings around Toroid Inductor

| | | | Total operation | | |
|---|---|---|---|---|---|
| Number of turns | Peak Voltage | | time (minutes | Frequency of | |
| of toroid | (Vpeak) | | and seconds) | resonance (kHz) | |
| 4 | 3 | V | 4 min 25 sec | 119-120 | kHz |
| 5 | 3 | V | 4 min 30 sec | 86-87 | kHz |
| 6 | 3.2 | V | 4 min 35 sec | 68-69 | kHz |
| 7 | 3.25 | V | 4 min 40 sec | 54-55 | kHz |
| 8 | 3.3 | V | 4 min 50 sec | 45-48 | kHz |
| 9 | 3.3 | V | 5 min | 38-40 | kHz |
| 10 | 3.3 | V | 5 min 10 sec | 35-36 | kHz |
| 11 | 3.3 | V | 5 min 14 sec | 30-31 | kHz |
| 12 | 3.3 | V | 5 min 25 sec | 28-29 | kHz |
| 13 | 3.3 | V | 5 min 30 sec | 25-26 | kHz |
| 14 | 3.4 | V | 5 min 40 sec | 22-24 | kHz |
| 15 | 3.4 | V | 5 min 50 sec | 21 | kHz |
| 16 | 3.4 | V | 6 min 05 sec | 20 | kHz |
| 17 | 3.4 | V | 6 min 10 sec | 18-19 | kHz |
| 18 | 3.4 | V | 6 min 15 sec | 17 | kHz |
| 19 | 3.4 | V | 6 min 20 sec | 14.2-14.6 | kHz |
| 20 | 3.4 | V | 6 min 30 sec | 13.5-14 | kHz |
| 21 | 3.4 | V | 6 min 50 sec | 13 | kHz |
| 22 | 3.4 | V | 7 min 10 sec | 12 | kHz |
| 23 | 3.4 | V | 8 min | 11.4 | kHz |
| 24 | 3.4 | V | 12 min | 10.2 | kHz |
| 25 | 3.4 | V | 12 min 20 sec | 9.5 | kHz |
| 26 | 3.4 | V | 14 min | 9.8 | kHz |
| 27 | 3.4 | V | 15 min | 9.52 | kHz |
| 28 | 3.4 | V | 15 min | 9.1 | kHz |
| 29 | 3.4 | V | 15 min | 8.9 | kHz |
| 30 | 3.4 | V | 15 min 10 sec | 8.77 | kHz |
| 31 | 3.45 | V | 15 min 30 sec | 8.6 | kHz |
| 32 | 3.5 | V | 15 min 50 sec | 8.4 | kHz |
| 33 | 3.5 | V | 16 min 10 sec | 8.2 | kHz |
| 34 | 3.5 | V | 16 min 40 sec | 7.52 | kHz |
| 35 | 3.5 | V | 17 min | 7.35 | kHz |

As can be seen in table 1 above, as the number of turns on each winding on the toroid core increase, the frequency of resonance decreases and the amount of time that the LED operates for increases. In addition, as the number of turns on each winding on the toroid core increase, the peak voltage increases as well. The increase in the number of turns on each winding on toroid core has a directly proportional relationship with the amount of operation time for the LED and the output peak voltage. In addition, the increase in the number of turns on each winding on the toroid core has an inversely proportional relationship with the frequency of resonance.

The LED requires a voltage of above 2.7 volts to operate with at a sufficient level of brightness. It is observed that after the circuit is powered for 9 to 10 seconds, where the number of turns is greater than 30, that the LED remains bright for approximately 10 minutes before starting to dim, and as such, it is observed that where the number of turns is greater than 30 for the windings in toroid inductor that a voltage of above 2.7 volts is generated for 10 minutes. As the voltage falls below 2.7 volts, the LED begins to dim, and the frequency of resonance also increases. For example, in referring to Table 1, where the number of turns is 30, the total operation time observed was 15 minutes and 10 seconds, of which the initial 10 minutes that the LED was bright (not diminished in its output), the voltage was above 2.7 volts. As such, the remaining 5 minutes and 10 seconds, the voltage in circuit 100 was below 2.7 volts. It was also observed that at the dimming point of the LED, the frequency of resonance is approximately 50 kHz.

### Example 2

The proportional relationship between the number of turns and the operation time of the load continue to hold with an increase in toroid inductor diameter. Similarly, the inversely proportional relationship between the number of turns and the frequency of resonance also continue to hold with the increase in toroid inductor diameter. The results in of Examples 2, 3, and 4 as depicted in tables 2, 3, and 4 alter the toroid core size of toroid inductor 120, and include a fixed supercapacitor 108 capacitance of 25 farads, where supercapacitor 108 is the hybrid type of supercapacitor. Similar to the variables in Example 1, the battery 104 provided was with voltage between 1.25 volts to 1.29 and connected to the circuit 100 for a duration of 9 to 10 seconds before being disconnected from circuit 100. With regards to Example 2, as can be seen in Table 2, below, a toroid inductor, where the toroid core has an outer diameter of 20 mm, an inner diameter of 15 mm and a height of 7 mm was used, where the number of turns of the primary and secondary winding of wires were incrementally increased, while the peak voltage, total operation time and frequency of resonance were measured.

TABLE 2
Affects of Multiple Windings around Toroid
Inductor with outer diameter of 20 mm

| | | Total operation | |
|---|---|---|---|
| Number of turns | Peak Voltage | time (minutes | Frequency of |
| of toroid | (Vpeak) | and seconds) | resonance (kHz) |
| 25 | 3.5 V | 18 | 2.40 kHz |
| 26 | 3.5 V | 18 min 50 sec | 2.31 kHz |
| 27 | 3.5 V | 19 min 00 sec | 2.23 kHz |
| 28 | 3.5 V | 19 min 20 sec | 2.15 kHz |
| 29 | 3.5 V | 20 min 15 sec | 2.03 kHz |
| 30 | 3.5 V | 21 min 30 sec | 1.98 kHz |
| 31 | 3.5 V | 21 min 50 sec | 1.92 kHz |
| 32 | 3.5 V | 22 min 15 sec | 1.91 kHz |
| 33 | 3.5 V | 22 min 30 sec | 1.80 kHz |
| 34 | 3.5 V | 23 min | 1.68 kHz |
| 35 | 3.5 V | 24 min | 1.62 kHz |

As can be seen from the values in table 2—as the number of turns/windings around the toroid core of the toroid inductor with an outer diameter of 20 mm increased, the total operation time of the load increased as well. Furthermore, as the number/windings around the toroid core of the toroid inductor with the outer diameter of 20 mm increased, the frequency of resonance decreased.

### Example 3

This is also confirmed with a toroid inductor with a toroid core with an outer diameter of 22.1 mm, an inner diameter of 13.7 mm and a height of 6.35 mm as used in Example 3. Table 3 below depicts, said toroid core with an outer diameter of 22.1 mm, being used, where the number of turns of the primary and secondary winding of wires were incrementally increased, while the peak voltage, total operation time and frequency of resonance were measured.

TABLE 3
Affects of Multiple Windings around Toroid
Inductor with outer diameter of 22.1 mm

| | | Total operation | |
|---|---|---|---|
| Number of turns | Peak Voltage | time (minutes | Frequency of |
| of toroid | (Vpeak) | and seconds) | resonance (kHz) |
| 25 | 3.5 V | 14 min 10 sec | 3.40 kHz |
| 26 | 3.5 V | 15 min 10 sec | 3.25 kHz |
| 27 | 3.5 V | 16 min 20 sec | 3.09 kHz |
| 28 | 3.5 V | 16 min 40 sec | 2.91 kHz |
| 29 | 3.5 V | 17 min | 2.85 kHz |
| 30 | 3.6 V | 17 min 15 sec | 2.78 kHz |
| 31 | 3.6 V | 17 min 30 sec | 2.66 kHz |
| 32 | 3.6 V | 18 min 30 sec | 2.55 kHz |
| 33 | 3.6 V | 21 min | 2.45 kHz |
| 34 | 3.6 V | 22 min | 2.36 kHz |
| 35 | 3.6 V | 25 min | 2.17 kHz |

### Example 4

Furthermore, the results for Example 4, specific to a toroid inductor with an outer diameter of 25.3 mm also confirm the same relationships. Table 4 below depicts, the toroid core with an outer diameter of 25.3 mm, an inner diameter of 14.8 mm and a height of 15 mm being used, where the number of turns of the primary and secondary winding of wires were incrementally increased, while the peak voltage, total operation time and frequency of resonance were measured.

TABLE 4
Affects of Multiple Windings around Toroid
Inductor with outer diameter of 25.3 mm

| | | | Frequency of | |
|---|---|---|---|---|
| Number of turns | Peak Voltage | Total operation | resonance | |
| of toroid | (Vpeak) | time (minutes) | (kHz/Hz) | |
| 25 | 3.6 V | 21 min 35 sec | 1.38 | kHz |
| 26 | 3.6 V | 23 min | 1.28 | kHz |
| 27 | 3.6 V | 23 min 30 sec | 1.20 | kHz |
| 28 | 3.6 V | 24 min 50 sec | 1.13 | kHz |
| 29 | 3.6 V | 25 min 45 sec | 1.07 | kHz |
| 30 | 3.6 V | 29 min | 1.01 | kHz |
| 31 | 3.6 V | 31 min | 960 | Hz |
| 32 | 3.6 V | 32 min | 919 | Hz |
| 33 | 3.6 V | 33 min 20 sec | 885 | Hz |
| 34 | 3.6 V | 35 min | 877 | Hz |
| 35 | 3.6 V | 36 min 10 sec | 862 | Hz |

While in Example 1, a supercapacitor 108 with a capacitance of 10 farads was used, Examples 2 to 4 used a supercapacitor 108 of 25 farads. Other supercapacitors 108 with different levels of capacitance are contemplated. Specifically, supercapacitors 108 with 25 farads or less are contemplated for use in alternate embodiments of circuit 100.

In addition, in Examples 1 to 4, the supercapacitor 108 was charged by attaching battery 104 to circuit 100 for a duration of 9 to 10 seconds before being disconnected. It has been found that preferably battery 104 is attached for a duration of at least 9 seconds or more to charge supercapacitor 108 before being disconnected. In certain preferred embodiments, battery 104 may be attached for a duration of 9 to 12 seconds to charge supercapacitor 108 before being disconnected. It may be possible to attach battery 104 to charge supercapacitor 108 for a duration of less than 9 seconds (and as low as 1 second), however this may shorten the total operation time of circuit 100. However, a person skilled in the art will recognize though that a battery 104 may be connected to circuit 100 for any amount of time to charge supercapacitor 108.

### Coefficient of Power

The coefficient of power represents the ratio of the output power to the input power. For example, with a toroid inductor 120 with 32 turns for secondary winding 204 and 32 turns for primary winding 208, the output voltage waveform can be seen as waveform 300 as depicted in FIG. 3, where the x axis depicts the time period, and the y axis depicts the voltage in volts. In the below calculations, the peak coefficient of power and the average coefficient of power are shown to be calculated for a toroid inductor 120 of circuit 100 with 32 turns for secondary winding 204, and primary winding 208.

The peak coefficient of power may be calculated as follows:

$$\\ Coefficient of Power ( Peak ) = \frac{Output Peak Power}{Input Peak Power}$$

The peak coefficient of power represents the coefficient of power achieved during the high voltage output pulses when transistor 132 is in a cut off region or in its “OFF” state.

Based on the values provided from waveform 300 and observations of the circuit, for the current embodiment with 32 turns for secondary winding 204 and primary winding 208, the peak coefficient of power is:

$$\\ Coefficient of Power ( Peak ) = \frac{( 3.4 V \times 40 mA )}{1.3 V \times 40 mA} = Approx . 2.61$$

As can be seen, during the high voltage output pulses, the peak coefficient of power is greater than one (1), achieving over unity during the high voltage output pulses, but returning to zero (0) when the transistor 132 is in a saturation region, and load 136 does not receive any power.

In calculating the average coefficient of power for the same toroid inductor 120 of circuit 100 with 32 turns, the average coefficient of power can be calculated as follows:

$$\\ Coefficient of Power ( Avg ) = \frac{Average Output Power in resonance circuit}{Average input power}$$

The calculation of the average output power may be calculated by multiplying the average output voltage and the average output current. To determine the average output voltage:

$$\\ {V}_{avg} = \frac{Area of waveform in one time period}{time period}$$

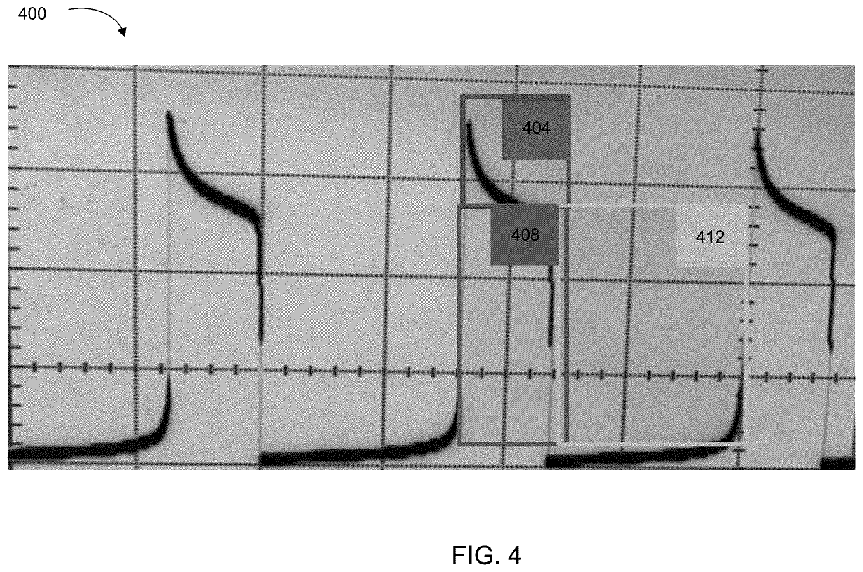

FIG. 4 depicts screenshot 400, which is an enlarged isolated shot of waveform 300 in FIG. 3, in which the area of a waveform can be calculated. In calculating the area under the waveform, approximations are used for simplicity. For example, while a curve does exist in area 404, the area under the curve will be approximated as a triangular area. This simplification will be used in other calculations below as well.

More specifically, the triangular area under the waveform in area 404, the area 408 and the empty area under the waveform in area 412 may be calculated, where the time period across areas 404 and 408 is 40 μs (the on-time of the transistor), and the time period across area 412 is 78 μs. This provides a total time period of 118 μs. In addition, as provided, the height of area 404 is approximately 1100 mV, and the height of area 408 is approximately 2500 mV. As such, to calculate the average voltage:

$$\\ {V}_{input avg} = \frac{0.5 ( 1100 \times 40 ) + ( 2500 \times 40 ) + ( 0 \times 78 )}{118} = 1033.8 mV$$

To determine the average output current:

$$\\ {I}_{avg} = \frac{Area of waveform in one time period}{time period}$$

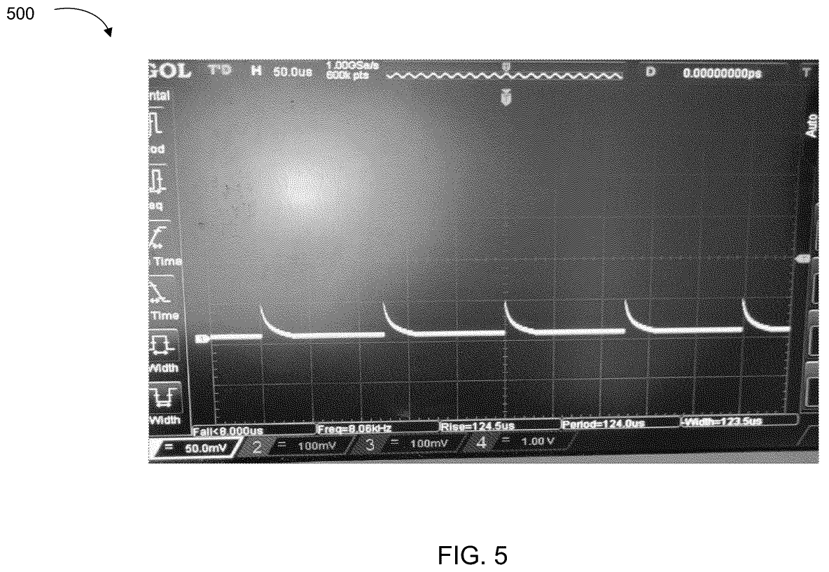

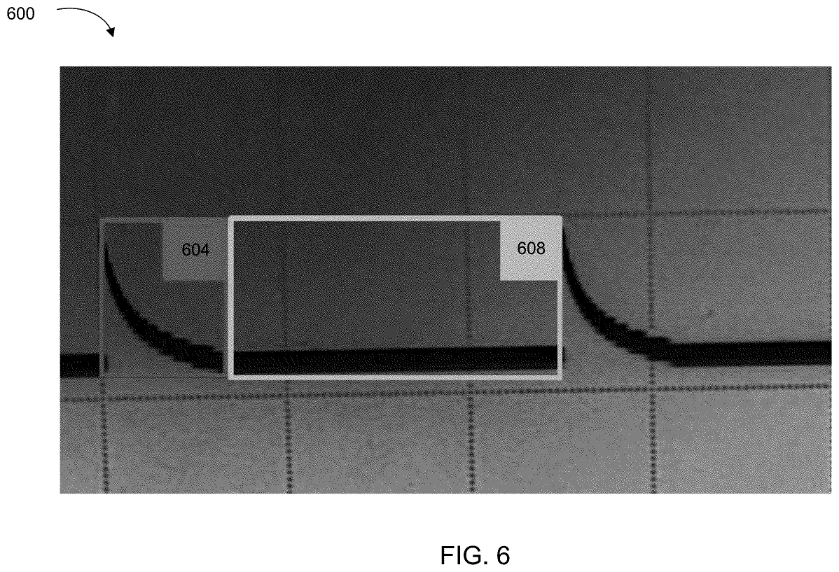

FIG. 5 depicts waveform 500 showcasing the output current over time, where the x axis depicts time period, and the y axis depicts mA. FIG. 6 depicts screenshot 600, which is an enlarged isolated shot of waveform 500 in FIG. 5, in which the area of the waveform may be calculated. More specifically, the triangular area under the waveform in area 604 has a time period of 40 μs, and a height of 40 mA, and area 608 has a time period of 84 μs, and a height of 0 mA. This leads to the total time period as 124 μs. As such, the average output current is calculated as follows:

$$\\ {I}_{output avg} = \frac{0.5 ( 40 \times 40 ) + ( 0 \times 84 )}{124} = 6.44 mA$$

To determine the input voltage, the voltage may be measured across the input terminals of the circuit once the battery is removed. This is measured to be in the range of 900 mV to 940 mV.

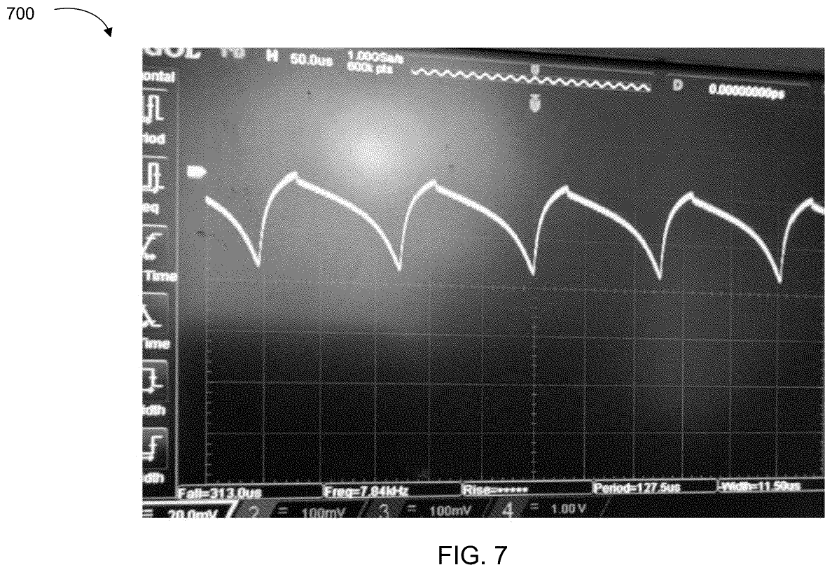

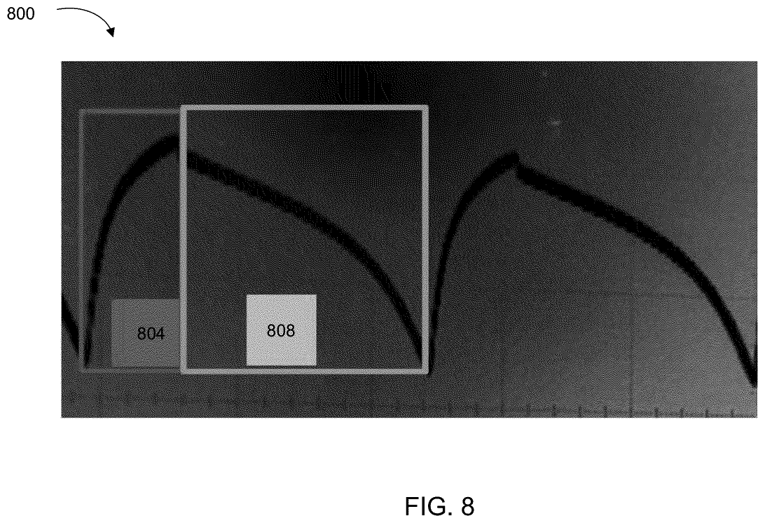

To determine the input current, the area under the input current waveform may be determined. FIG. 7 depicts the input current waveform 700, where the x axis depicts the time period, and the y axis depicts current in mA. FIG. 8 depicts screenshot 800, an enlarged isolated area of waveform 700. In calculating the area under the curve, area 804 has a time period of 30 μs and a height of 35 mA, and area 808 has a time period of 97.5 μs and a similar height of 35 mA. As such, the total time period for the cycle is 127.5 μs. The average input current is calculated as follows:

$$\\ {I}_{input avg} = \frac{0.5 ( 30 \times 35 ) + 0.5 ( 97.5 \times 35 )}{127.5} = 17.5 mA$$

Therefore, the average coefficient of power may be calculated as follows using the equation provided above:

$$\\ Coefficient of Power ( Avg ) = \frac{1033.8 mV \times 6.44 mA}{920 mV \times 17.5 mA} = 0.52$$

As can be seen, the average coefficient of power includes cycles in which transistor 132 is first in a saturation region, and then when the transistor 132 is in a cut off region. This means that the average coefficient of power includes both periods of time where high voltage pulses are being sent to load 136, and when no power is being sent to load 136.

It is believed that as the number of turns around secondary winding 204 and primary winding 208 increase, the both the average and peak coefficient of power increases as well. This indicates that as the number of turns increases, the efficiency of the circuit increases as well.

What is claimed is:

1. An electric circuit comprising:
a supercapacitor configured for connection in parallel to a removable power source capable of charging the supercapacitor, the supercapacitor having a positive terminal and a negative terminal;
a toroid inductor being configured to receive current from the positive terminal of the supercapacitor when the supercapacitor is actuated to discharge, the toroid inductor having a primary winding and a secondary winding, the primary winding and the secondary winding having a plurality of turns;
a transistor including a collector, a base, an emitter, and a collector-emitter junction;
a base biasing resistor being configured to ensure the base of the transistor receives safe current;
wherein the toroid inductor, the base biasing resistor, the transistor are connected in parallel to the supercapacitor and a load is connectable in parallel to the supercapacitor;
wherein the secondary winding of the toroid inductor is connected in series to the base biasing resistor, which in turn is connected to the base of the transistor, the primary winding of the toroid inductor is connected in series to the collector of the transistor, the emitter of the transistor is connected to the negative terminal of the supercapacitor, and the connectable load is connectable across the collector-emitter junction of the transistor; and
once charged the supercapacitor being actable to discharge so as to cause the primary and secondary windings to incite the transistor to alternate between a saturation region and a cut off region at a resonance frequency, to thereby direct current to the supercapacitor through the collector-emitter junction of the transistor while the transistor is in the saturation region, and to direct current with high voltage to the load while the transistor is in the cut off region.

2. The electric circuit of claim 1, wherein the number of turns around the primary winding and secondary winding is directly proportional to an operation time of the load.

3. The electric circuit of claim 1, wherein the number of turns around the primary winding and secondary winding is inversely proportional to the resonance frequency.

4. The electric circuit of claim 1, wherein an operation time of the load is inversely proportional to the resonance frequency.

5. The electric circuit of claim 1, wherein a diameter of a toroid core of the toroid inductor is directly proportional to an operation time of the load.

6. The electric circuit of claim 1, wherein a diameter of a toroid core of the toroid inductor is inversely proportional to the resonance frequency.

7. The electric circuit of claim 1 further comprising an input current sensing resistor connected between the emitter of the transistor and the negative terminal of the super capacitor, the input current sensing resistor being configured to aid in the measurement of the current input flowing through the supercapacitor.

8. The electric circuit of claim 1 further comprising an output current sensing resistor connected in series to an output of the load, the output current sensing resistor and the load connected across a collector-emitter junction of the transistor, the output current sensing resistor being configured to aid in the measurement of current output supplied to the load.

9. The electric circuit of claim 1, wherein the number of turns around the primary winding and the secondary winding is directly proportional to an average coefficient of power for the electric circuit.

10. The electric circuit of claim 1, wherein the number of turns around the primary winding and the second winding is directly proportional to a peak coefficient of power for the electric circuit while the transistor is in the cut off region.

11. The electric circuit of claim 1, wherein the removable power source is a depleted battery.

12. The electric circuit of claim 11, wherein the depleted battery is an alkaline AA battery that has a voltage of 1.3 volts or less.

13. The electric circuit of claim 1, wherein the removable power source is an AA battery that has a voltage between 1.0 volt and 1.5 volts.

14. The electric circuit of claim 1, wherein in the supercapacitor has a capacitance of between 10 farads and 25 farads.

15. The electric circuit of claim 1, wherein the supercapacitor is an electric double-layer capacitor.

16. The electric circuit of claim 1, wherein the supercapacitor is a hybrid supercapacitor.

17. The electric circuit of claim 1, wherein prior to the supercapacitor being actuated to discharge, the power source is connected in parallel to the supercapacitor for a duration of at least 1 second to charge the supercapacitor and then the power source is sub sequently disconnected.

18. The electric circuit of claim 1, wherein the removable power source is a removable battery with voltage between 1.25 volts and 1.3 volts.

19. The electric circuit of claim 18, wherein the supercapacitor was charged by connecting the removable battery for a duration of at least 9 seconds and then disconnecting the removable battery.

20. The electric circuit of claim 19, wherein the supercapacitor has a capacitance of 10 farads.

21. The electric circuit of claim 20, wherein the primary winding and secondary winding each have between 4 to 35 turns.

22. The electric circuit of claim 21, wherein the frequency of resonance was between 120 kHz and 7.35 kHz.

23. The electric circuit of claim 19, wherein the supercapacitor has a capacitance of 25 farads.

24. The electric circuit of claim 23, wherein the primary winding and secondary winding each have between 25 to 35 turns.

25. The electric circuit of claim 24, wherein the frequency of resonance was between 2.40 kHz and 1.62 kHz.

26. A method of powering a load, the method comprising:
providing:
a supercapacitor configured for connection in parallel with a removable power source, the supercapacitor having a positive terminal and a negative terminal;
a toroid inductor, a base biasing resistor, a transistor and a connectable load connected in parallel with the supercapacitor,
the toroid inductor connected to the positive terminal of the supercapacitor, the toroid inductor having a primary winding and a secondary winding, the primary winding and the secondary winding having a plurality of turns;
the transistor including a collector, a base, an emitter and a collector-emitter junction; and
the secondary winding of the toroid inductor being connected in series to the base biasing resistor, which in turn is connected to the base of the transistor, the primary winding of the toroid inductor being connected to the collector of the transistor, the emitter of the transistor being connected to the negative terminal of the supercapacitor, and the connectable load being connected across a collector-emitter junction of the transistor;
charging the supercapacitor through connecting the removable power source for a predetermined duration of time, and subsequently disconnecting the removable power source;
discharging a current from a charged supercapacitor to the toroid inductor;
inciting the transistor to alternate between a saturation region and a cut off region at a resonance frequency using the primary winding and secondary winding of the toroid inductor;
while the transistor in a saturation region, directing current to the supercapacitor through the collector-emitter junction of the transistor; and
while the transistor in a cut off region, directing current with high voltage to the load.

27. The method of claim 26, wherein the number of windings around the primary winding and secondary winding is directly proportional to an operation time of the load.

28. The method of claim 26, wherein the number of turns around the primary winding and secondary winding is inversely proportional to the resonance frequency.

29. The method of claim 26, wherein an operation time of the load is inversely proportional to the resonance frequency.

30. The method of claim 26, wherein a diameter of a toroid core of the toroid inductor is directly proportional to an operation time of the load.

31. The method of claim 26, wherein a diameter of a toroid core of the toroid inductor is inversely proportional to the resonance frequency.

32. The method of claim 26, wherein the number of turns around the primary winding and the secondary winding is directly proportional to an average coefficient of power for the electric circuit.

33. The method of claim 26, wherein the number of turns around the primary winding and the second winding is directly proportional to a peak coefficient of power for the electric circuit while the transistor is in the cut off region.

34. The method of claim 26, wherein the removable power source is a depleted battery.

35. The method of claim 34, wherein the depleted battery is an alkaline AA battery that has a voltage of 1.3 volts or less.

36. The method of claim 26, wherein the removable power source is an AA battery that has a voltage between 1.0 volt and 1.5 volts.

37. The method of claim 26, wherein the supercapacitor has a capacitance between 10 farads and 25 farads.

38. The method of claim 26, wherein the predetermined duration of time is at least 1 second.

39. The method of claim 26, wherein the predetermined duration of time is between 9 seconds and 12 seconds.

40. The method of claim 26, wherein the predetermined duration of time is between 9 seconds and 10 seconds.

41. An electric circuit comprising:
a supercapacitor having a capacitance between 10 farads and 25 farads, the supercapacitor configured for connection in parallel to a removable power source capable of charging the supercapacitor, the removable power source having a voltage less than 1.3 volts, the supercapacitor having a positive terminal and a negative terminal;
a toroid inductor being configured to receive current from the positive terminal of the supercapacitor when the supercapacitor is actuated to discharge, the toroid inductor having a primary winding and a secondary winding, the primary winding and the secondary winding having a plurality of turns;
a transistor including a collector, a base, an emitter, and a collector-emitter junction;
a base biasing resistor being configured to ensure the base of the transistor receives safe current;
wherein the toroid inductor, the base biasing resistor, the transistor are connected in parallel to the supercapacitor and a load is connectable in parallel to the supercapacitor;
wherein the secondary winding of the toroid inductor is connected in series to the base biasing resistor, which in turn is connected to the base of the transistor, the primary winding of the toroid inductor is connected in series to the collector of the transistor, the emitter of the transistor is connected to the negative terminal of the supercapacitor, and the connectable load is connectable across the collector-emitter junction of the transistor; and
once charged by the removable power source for a duration at least 9 seconds the supercapacitor being actable to discharge so as to cause the primary and secondary windings to incite the transistor to alternate between a saturation region and a cut off region at a resonance frequency, to thereby direct current to the supercapacitor through the collector-emitter junction of the transistor while the transistor is in the saturation region, and to direct current with high voltage to the load while the transistor is in the cut off region.

42. The electric circuit of claim 41, wherein the supercapacitor has a capacitance of 10 farads, and the primary winding and secondary winding each having between 4 to 35 turns.

43. The electric circuit of 41, wherein the supercapacitor has a capacitance of 25 farads, and the primary winding and secondary winding each having between 25 to 35 turns.
